(19) United States
(12) Patent Application Publication
(10) Pub. No.: US 2020/0052915 A1
(43) Pub. Date: Feb. 13, 2020

(54) METHOD FOR MANAGING AN OPERATING MODE OF AN ITEM OF EQUIPMENT

(71) Applicant: SAGEMCOM BROADBAND SAS, Rueil Malmaison (FR)

(72) Inventors: Florent DUCHON, Rueil Malmaison (FR); Jerome BERGER, Rueil Malmaison (FR)

(73) Assignee: SAGEMCOM BROADBAND SAS, Rueil Malmaison (FR)

(21) Appl. No.: 16/342,791

(22) PCT Filed: Oct. 27, 2017
(86) PCT No.: PCT/EP2017/077560

§ 371 Date: Apr. 17, 2019

(30) Foreign Application Priority Data
Oct. 28, 2016 (FR) 1660494

(51) Int. Cl. H04L 12/12; G06F 1/3209; G06F 1/3231; G06F 1/3287

(52) U.S. Cl. CPC H04L 12/12; G06F 1/3287; G06F 1/3231; G06F 1/3209

(57) ABSTRACT

An equipment can function according to a plurality of operating modes that include a deep standby mode in which the energy consumption is minimum, an active mode in which the energy consumption is maximum and a light standby mode in which the energy consumption is intermediate between deep standby and active mode, a change from the deep standby mode to the active mode being slower than a change from the light standby mode to the active mode. The method enables an electricity meter supervising an electricity network to which an item of equipment is connected to control the change of said equipment to light standby mode. To do this, the meter implements a procedure for the detection of human presence based on an analysis of the electrical consumption in the electricity network and activates the light standby mode of the equipment when a user is detected.

The invention relates to a method for managing an operating mode of an item of equipment that can function in a plurality of operating modes comprising a deep standby mode in which electrical consumption of said equipment is minimum, an active mode in which the electrical consumption of the equipment is maximum and a light standby mode in which the electrical consumption of the equipment is intermediate between the deep standby mode and the active mode, and a device, equipment or system implementing the method.

Historically, electronic equipment was connected, used and then switched off between two uses. With an increasing need for availability of equipment, a problem of keeping said equipment in almost permanent operation has been posed. Keeping in permanent operation at full operability obviously poses many problems: high electrical consumption, mechanical wear of moving parts, wear on electronic components, noise nuisance, etc. An intermediate solution consists of making the equipment go into a reduced-activity mode or stopping some components of the equipment, while keeping essential components active. Thus, once the equipment is on standby, it remains waiting and is reactivated as required, and this much more quickly than if it had been completely switched off and switched on once again.

Some items of equipment have a plurality of standby modes. Each standby mode is associated with an electrical consumption level and a required reaction time. This is the case with some data processing equipment such as computers, tablets, smartphones and set top boxes.

A set top box is typically an item of equipment that must have minimum consumption when no user is liable to use it and which, despite everything, must be able to start as quickly as possible when the user so wishes. Some set top boxes can thus function in a so-called deep standby mode in which the electrical consumption of the set top box is minimum, an active mode in which the electrical consumption of the set top box is maximum and a light standby mode in which the electrical consumption of the set top box is intermediate between the deep standby mode and the active mode. For example in deep standby mode the set top box may stop supplying each device not necessary for the awakening of the set top box (video decoding chip, hard disk drive, main processor, etc.) and keep only essential devices awake (infrared receiver for remote control, network interface for remote awakening, microcontroller for interpreting signals received from the remote control and/or from the network and managing planned wake-ups). In light standby mode, the set top box has all its devices supplied and its main software initialised as in normal operation, but it keeps video and audio outputs stopped. When a set top box goes into light standby mode, some of the internal devices of this set top box are deactivated and/or the power supply to these internal devices is cut off. In light standby mode, the apparatus may also keep stopped some peripherals that have rapid starting or require action by a user. In active mode, all the devices of the set top box are powered.

Using planning so that equipment is in light standby during certain time ranges and in deep standby the rest of the time is known. The planning may be fixed or obtained automatically by learning according to habits of one or more users, as in the documents US 2011/182597 and FR 2984541. However, these methods are not capable of adapting to exceptional behaviours of the user. For example, if the user is exceptionally absent from home during a planned period in which the equipment must function in light standby mode, the equipment consumes more than it should. Conversely, if the user returns home sooner than normal, the equipment is in deep standby mode and is slow to start.

It is desirable to overcome these drawbacks of the prior art. It is in particular desirable to propose a method for optimising a compromise between energy saving for the electronic equipment and reactivity of this equipment to starting. It is moreover desirable for this method to be capable of adapting to real requirements of the user rather than according to his habits, as finely determined as they may be.

It is also desirable to propose a method that is simple to implement at low cost.

According to a first aspect of the present invention, the present invention relates to a system comprising an item of equipment and an electricity meter, the equipment being able to function in a plurality of operating modes comprising a deep standby mode in which electrical consumption of said equipment is minimum, an active mode in which the electrical consumption of the equipment is maximum and a light standby mode in which the electrical consumption of the equipment is intermediate between the deep standby mode and the active mode, some of the internal devices of the equipment being deactivated and/or the power supply to these internal devices being cut off when the equipment goes into light standby mode, a change from deep standby mode to active mode being slower than a change from light standby mode to active mode, the equipment being supplied by an electrical network of a building supervised by the electricity meter, the equipment and the electricity meter being able to communicate by means of a communication network. The electricity meter comprises: detection means for detecting a human presence in the building by analysing the electrical consumption in the electrical network; transmission means for sending a message to the equipment by means of the communication network requesting a change of the equipment to light standby mode when a human presence is detected; and the equipment comprises: reception means for receiving said message by means of the communication network, and processing means for making the equipment go into light standby mode.

Thus the system allows to adapt the electrical consumption of equipment to a real requirement of the user. It allows in particular to adapt the electrical consumption.

According to a second aspect of the invention, the invention relates to a method for managing an operating mode of an item of equipment that can function in a plurality of operating modes comprising a deep standby mode in which electrical consumption of said equipment is minimum, an active mode in which the electrical consumption of the equipment is maximum and a light standby mode in which the electrical consumption of the equipment is intermediate between the deep standby mode and the active mode, some of the internal devices of the equipment being deactivated and/or the power supply to these internal devices being cut off when the equipment goes into light standby mode, a change from the deep standby mode to the active mode being slower than a change from said light standby mode to the active mode, the equipment being supplied by an electrical network of a building supervised by an electricity meter able to communicate with the equipment by means of a communication network. The method implemented by the electricity meter comprises: using a procedure for detecting a human presence in the building based on an analysis of the electrical consumption in the electrical network; and, when a human presence is detected, sending (31) a message to the equipment, by means of the communication network, requesting that the equipment go into light standby mode.

According to one embodiment, the building comprises a plurality of zones and the electricity meter is able to measure electrical consumption in each of the zones independently, said message being sent when a human presence is detected in at least one of the zones.

According to one embodiment, the procedure for detecting a human presence based on an analysis of the electrical consumption comprises detecting at least a variation in an electrical power consumed in said electrical network.

According to one embodiment, the building comprises a plurality of devices, each device being associated with a type of electrical consumption, and the electricity meter is capable of measuring a current consumption by type of electrical consumption, said message being sent when a consumed electrical power higher than a predefined threshold is detected for at least one type of electrical consumption.

According to one embodiment, the consumed electrical power is that of at least one lighting device supplied by the electrical network.

According to one embodiment, the procedure for detecting a human presence based on an analysis of the electrical consumption comprises seeking at least one electrical consumption profile characteristic of a human presence in the building.

According to a third aspect of the invention, the invention relates to a method for managing an operating mode of an item of equipment that can function in a plurality of operating modes comprising a deep standby mode in which electrical consumption of said equipment is minimum, an active mode in which the electrical consumption of the equipment is maximum and a light standby mode in which the electrical consumption of the equipment is intermediate between the deep standby mode and the active mode, some of the internal devices of the equipment being deactivated and/or the electrical supply to these internal devices being cut off when the equipment goes into light standby mode, a change from deep standby mode to active mode being slower than a change from light standby mode to active mode, the equipment being supplied by an electrical network of a building supervised by an electricity meter able to communicate with the equipment by means of a communication network. The method used by the equipment comprises: receiving a message by means of the communication network requesting change of the equipment to light standby mode, the message having been sent by the electricity meter following detection of a human presence in the building by a procedure for detecting a human presence based on an analysis of the electrical consumption in the electrical network, and causing the equipment to go into light standby mode.

According to one embodiment, the equipment may be in a plurality of states according to at least one predetermined criterion, the plurality of states comprising a first state in which the operating mode is forced to light standby mode and/or a second state in which the operating mode is forced to deep standby mode and a third state in which the operating mode is not forced, the equipment taking into account a message requesting a change of the equipment to light standby mode only when it is in the third state.

According to one embodiment, a predetermined criterion is a set of time ranges comprising a time range during which the equipment is in the first state, a time range during which the equipment is in the second state and a time range during which the equipment is in the third state.

According to one embodiment, each time range corresponding to the first and second state is determined by a procedure for automatically determining periods during which the equipment must be in deep standby mode or in light standby mode, said procedure being based on an analysis of moments of use of the equipment by at least one user, a time range of a predetermined duration and corresponding to the third state being added before and/or after each time range corresponding to the first state determined by said procedure.

According to one embodiment, a predetermined criterion is a level of brightness in at least one zone of the building, the equipment being in the first state when the level of brightness is above a predefined threshold and in the third state when the level of brightness is below said predefined threshold.

According to a fourth aspect of the invention, the invention relates to an electricity meter comprising means for implementing the method according to the second aspect.

According to a fifth aspect of the invention, the invention relates to equipment comprising means for implementing the method according to the third aspect.

According to a sixth aspect of the invention, the invention relates to a computer program comprising instructions for the implementation, by a device, of the method according to the second aspect or the third aspect, when said program is executed by a processor of said device.

According to a seventh aspect of the invention, the invention relates to storage means storing a computer program comprising instructions for the implementation, by a device, of the method according to the second aspect or the method according to the third aspect, when said program is executed by a processor of said device.

The features of the invention mentioned above, as well as others, will emerge more clearly from a reading of the following description of an example embodiment, said description being given in relation to the accompanying drawings, among which:

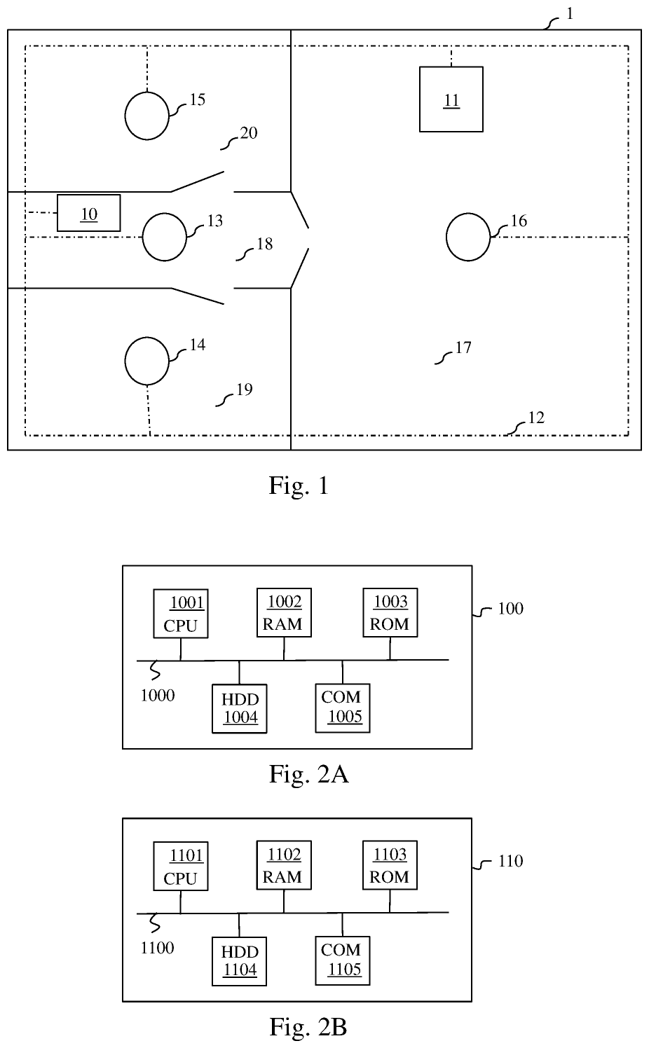

FIG. 1 illustrates schematically a context in which the invention is implemented;

FIG. 2A illustrates schematically a processing module included in an electricity meter;

FIG. 2B illustrates schematically a processing module included in an item of equipment;

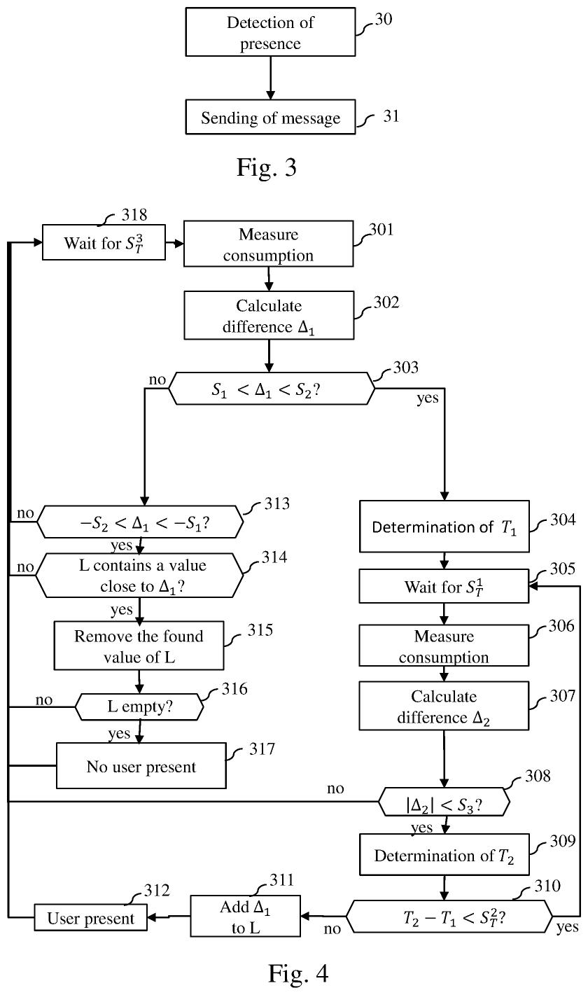

FIG. 3 illustrates schematically a method according to the invention, implemented by the electricity meter, for sending messages to an item of equipment;

FIG. 4 illustrates schematically a method for detecting a human presence based on an analysis of variation in an electrical power consumed;

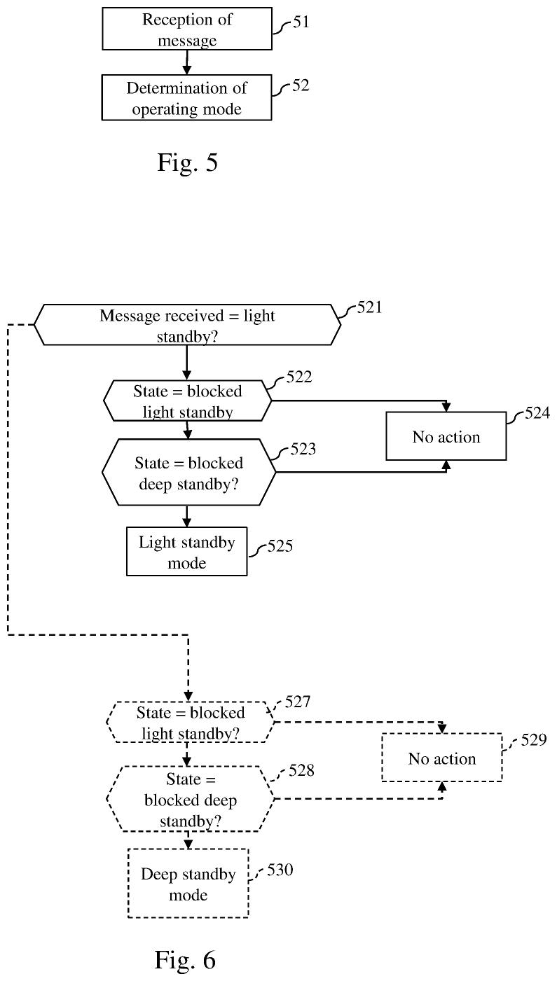

FIG. 5 illustrates schematically a method for determining an operating mode of an item of equipment according to the invention; and

FIG. 6 illustrates schematically a detail of the method for determining an operating mode of an item of equipment according to the invention.

The invention is described hereinafter in a context where the equipment is a set top box. This method is however suitable for any equipment that can function in a plurality of standby modes and is connected to an electricity meter by a communication network. Moreover, this method is suitable when any one building comprises a plurality of items of equipment that can function in a plurality of standby modes.

FIG. 1 illustrates schematically a context in which the invention is implemented.

FIG. 1 shows a simplified plan view of a building 1 comprising a plurality of zones 17, 18, 19 and 20. The building 1 comprises an electrical network 12 supervised by a smart electricity meter 10 and to which a set top box 11 is connected. Each zone comprises a lighting system supplied by the electrical network 12. Thus the zone 17 (and respectively the zone 18, 19, 20) comprises a lighting system 16 (and respectively a lighting system 13, 14, 15). The electricity meter 10 is capable of communicating with the set top box 11 through a communication network, not shown. The communication network is for example a power line communication network, and in this case the electrical network 12 becomes a communication network, a cabled network of the Ethernet type or a wireless network of the Wi-Fi type (in accordance with the standards in the IEEE 802.11 group) or ZigBee type based on IEEE 802.15.4.

FIG. 2A illustrates schematically a processing module 100 included in the electricity meter 10.

According to the example of hardware architecture shown in FIG. 2A, the processing module 100 then comprises, connected by a communication bus 1000: a processor or CPU (central processing unit) 1001; a random access memory (RAM) 1002; a read only memory (ROM) 1003; a storage unit such as a hard disk or a storage medium reader, such as an SD (secure digital) card reader 1004; at least one communication interface 1005 enabling the processing module 100 to communicate with other modules or devices. For example, the communication interface 1005 is an Ethernet module, a power line communication module, a Wi-Fi module or a ZigBee module. The communication interface 1005 enables the processing module 100 to send messages to a communication interface 1105 included in the set top box 11.

The processor 1001 is capable of executing instructions loaded into the RAM 1002 from the ROM 1003, from an external memory (not shown), from a storage medium (such as an SD card) or from a communication network. When the electricity meter 10 is powered up, the processor 1001 is capable of reading instructions from the RAM 1002 and executing them. These instructions form a computer program causing the implementation by the processor 1001 of the steps of the methods described below in relation to FIGS. 3 and 4.

The steps of the methods described in relation to FIGS. 3 and 4 can be implemented in software form by the execution of a set of instructions by a programmable machine, for example a DSP (digital signal processor) or a microcontroller, or be implemented in hardware form by a machine or a dedicated component, for example an FPGA (field-programmable gate array) or an ASIC (application-specific integrated circuit).

FIG. 2B illustrates schematically an example of hardware architecture of the processing module 110 included in the set box top 11.

According to the example of hardware architecture shown in FIG. 2B, the processing module 110 then comprises, connected by a communication bus 1100: a processor or CPU 1101; a random access memory (RAM) 1102; a read only memory (ROM) 1103; a storage unit such as a hard disk or a storage medium reader, such as an SD card reader 1104; at least one communication interface, such as the communication interface 1105 mentioned above, enabling the processing module 110 to communicate with the communication interface 1005.

The processor 1101 is capable of executing instructions loaded into the RAM 1102 from the ROM 1103, from an external memory (not shown), from a storage medium (such as an SD card) or from a communication network. When the set top box is powered up, the processor 1101 is capable of reading instructions from the RAM 1102 and executing them. These instructions form a computer program causing the implementation by the processor 1101 of the steps of the methods described below in relation to FIGS. 5 and 6.

The steps of the methods described in relation to FIGS. 5 and 6 may be implemented in software form by the execution of a set of instructions by a programmable machine, for example a DSP (digital signal processor) or a microcontroller, or be implemented in hardware form by a machine or a dedicated component, for example an FPGA (field-programmable gate array) or ASIC (application-specific integrated circuit).

In one embodiment, the set top box 11 further comprises at least one clock device providing timing information to the processor 1101 and/or to the RAM 1102 and/or to the ROM 1103, etc., at least one network card, devices of the hardware accelerator type, and input/output devices (tuner, audio/video output, network interfaces, receiver for remote-control signal, etc.). When going into light standby mode, each clock device is slowed to the maximum so as to provide timing information having a minimum frequency. Moreover, in light standby mode, the hardware accelerators and input/output devices are stopped except for the devices necessary for waking up. Some devices, such as a tuner or certain network cards, require microcode loading. Microcode loading is a relatively lengthy operation. When going into light standby mode, the loading of the microcodes is in general carried out in advance, and the devices concerned remain powered up so as not to lose the microcode loaded. However, these devices are not necessarily initialised or configured, which allows to limit the energy consumption.

FIG. 3 illustrates schematically a method according to the invention, implemented by the electricity meter 10, for sending messages to the set top box 11.

In a step 30, the processing module 100 implements a procedure for detecting a human presence in the building 1 based on an analysis of electrical consumption in the electrical network 12.

When a human presence is detected in the building 1, in a step 31 the processing module 100 sends a message to the processing module 110 of the set top box 11, by means of the communication network, requesting that the set top box 11 go into light standby mode.

In one embodiment, the procedure for detecting a human presence in the building 1 based on the analysis of the electrical consumption comprises detecting at least one variation in an electrical power consumed in the electrical network. To do this, in one embodiment, the processing module 100 implements a method for detecting a human presence based on an analysis of electrical consumption described in relation to FIG. 4. This method is particularly suited to detection of a switching on of a lighting system. It is assumed here that the switching on of a lighting system represents a human presence in a building. A lighting system in general functions with a consumption of between 10 W and 200 W. When an increase in consumption of this order of magnitude is observed in an electrical network, it can be deduced from this that a user is present in the building. In one embodiment, the electricity meter 11 is capable of distinguishing the electrical consumption of a lighting system from other electrical consumptions.

FIG. 4 illustrates schematically a method for detecting a human presence based on an analysis of variation in a consumed electrical power.

In a step 301, the processing module obtains a measurement of electrical consumption made by the electricity meter 10. The measurement of consumption obtained during step 301 is referred to as the current consumption measurement. In a step 302, the module calculates a difference Δ₁ between the current consumption measurement and a consumption measurement referred to as the previous consumption measurement, made during a previous performance of step 301. The previous and current consumption measurements are for example successive consumption measurements. In a step 303, the processing module 100 determines whether the difference Δ₁ is between a threshold S₁ and a threshold S₂. In one embodiment S₁=10 W and S₂=200 W.

When, during step 303, the difference Δ₁ is between the threshold S₁ and the threshold S₂, the processing module 100 passes to step 304.

During step 304, the processing module 100 determines and stores a current time value T₁.

In a step 305, the processing module 100 waits for a period S_{T}¹ and then during a step 306 the processing module 100 makes a consumption measurement. The period S_{T}¹ is chosen so as to have sufficient difference in time between two consumption measurements. In one embodiment, the period S_{T}¹ is equal to “1 second”.

In a step 307, the processing module 100 calculates a difference Δ₂ between the last two consumption measurements.

In a step 308, the processing module 100 compares an absolute value of the difference Δ₂ with a threshold S₃. The threshold S₃ represents a variation in consumption so small that it is considered to be negligible. In one embodiment S₃ is equal to “0.1 W”. When the absolute value of the difference Δ₂ is less than S₃ the processing module 100 considers that the variation in consumption over the last period S_{T}¹ is negligible and passes to a step 309 during which the processing module determines a current time T₂.

In a step 310, the processing module 100 calculates a difference between the times T₂ and T₁ and compares this difference with a threshold S_{T}². The threshold S_{T}² is a period making it possible to check whether a variation in consumption measured during step 303 has a sufficiently long duration to be considered to be significant. The threshold S_{T}² is for example equal to “10 seconds”.

If the difference between the times T₂ and T₁ is less than the threshold S_{T}², the processing module 100 returns to the step 305 already explained.

If the difference between the times T₂ and T₁ is greater than or equal to the threshold S_{T}² the processing module implements a step 311 during which it stores, in a list of consumption differences L, the value of the consumption difference Δ₁.

Step 311 is followed by a step 312 during which the processing module 100 considers that a user is present in the building. As soon as a user has been detected in the building, the processing module implements step 31.

Step 312 is followed by a step 318 during which the processing module 100 waits for a period S_{T}³. The period S_{T}³ is chosen according to the same criteria as the period S_{T}². In one embodiment, S_{T}³ is equal to “1 second”.

Step 318 is followed by the step 310 already explained.

When, during step 308, the absolute value of the difference Δ₂ is greater than the threshold S₃ the processing module 100 considers that the duration of the variation in consumption is not significant and continues with the step 318 already explained.

When during step 303 the difference Δ₁ does not lie between the threshold S₁ and the threshold S₂, the processing module 100 passes to a step 313 in order to check whether there has been a drop in consumption during the last second of measurement representing a departure of a user from the building. During step 313, the processing module 100 checks whether the difference Δ₁ lies between a threshold −S₂ and a threshold −S₁. If such is not the case, the processing module implements step 318.

In a step 314, the processing module 100 checks whether a difference equal to the difference value Δ₁ is present in the list of differences L. If such is not the case, the processing module implements step 318.

If a difference equal to the difference value Δ₁ is present in the difference list L, the processing module 100 removes this difference having a value equal to Δ₁ from the list of differences L during a step 315.

In a step 316, the processing module checks whether the list of differences L is empty. If the list of differences L is not empty, the processing module 100 continues with step 318. If the list of differences L is empty, the processing module 100 deduces from this, during a step 317, that no user is present in the building 1. Step 317 is followed by step 318.

The method described in relation to FIG. 4 is an example of a method for detecting a human presence based on an analysis of electrical consumption. In one embodiment, the electricity meter 10 is capable of measuring a current consumption by zone. In the example of the building 1, the electricity meter 10 is capable of measuring the electrical consumption independently in each of the zones 17 to 20. In this embodiment, the method in FIG. 4 is implemented in at least one of the zones 17, 18, 19 and 20. For example, the zone 18 being an entrance of the building 1, the method described in relation to FIG. 4 is implemented solely in this zone.

In one embodiment, the electricity meter 10 is capable of measuring a current consumption by type of consumption. For example, the electricity meter 10 is capable of distinguishing the electrical consumption due to the lighting systems of the building 1 from the electrical consumption due to a heating system, and from the electrical consumption due to other appliances. In the example of the building 1, the electricity meter 10 is capable of measuring specifically an electrical consumption for the lighting systems 13, 14, 15 and 16 independently of the total electrical consumption of the building. In this embodiment, the electricity meter 10 considers that a user is present in the building since the electrical consumption of the lighting systems is higher than a predefined threshold. For example, this threshold is equal to “0.1 W”.

In one embodiment, the procedure for detecting a human presence based on an analysis of the electrical consumption comprises seeking at least one electrical consumption profile characteristic of a human presence in the building 1. For example, it is not rare that, when a user enters a building, he opens an automatic garage door. An opening of a garage door causes an increase in electrical consumption that is always identical (the consumption of electricity necessary for opening the automatic garage door) for a period that is always identical (the period necessary for the garage door to go from a closed position to an open position). During this period, the change in the electrical consumption is almost systematic. An opening of a garage door can therefore for example be characterised by a plurality of items of information recognisable by the electricity meter 10, such as for example a level of increase in electrical consumption, a duration of this increase, and a variance of this increase. These three items of information constitute a profile that is characteristic of a presence of a user in the building 1. In this embodiment, the processing module 10 therefore continually seeks, in its energy consumption measurements, profiles corresponding to known profiles.

In one embodiment, the processing module 100 applies a presence detection algorithm based on a search for at least one electrical consumption profile described in the document “Non-Intrusive Occupancy Monitoring using Smart Meters, D. Chen, S. Barker, A. Subbaswamy, D. Irvin, P. Shenoy, University of Massachusetts Amherst”.

In one embodiment, the processing module 100 applies a presence detection algorithm described in the article “PresenceSense: Zero-training Algorithm for Individual Presence Detection Based on Power Monitoring, Ming Jin et al., University of California, Berkeley”.

In one embodiment, each message containing a request to go into light standby mode transmitted during step 31 adopts a format similar to a message of the magic packet type of the Wake-on-LAN (local area network) protocol described in the document “Magic Packet Technology: White Paper, http://support.amd.com/TechDocs/20213.pdf”. The Wake-on-LAN protocol is an Ethernet network standard enabling a device such as a computer to be switched on remotely. A magic packet is an Ethernet frame containing (in hexadecimal) bytes FF FF FF FF FF FF followed by sixteen repetitions of a MAC (medium access control) address of a target device. In this embodiment, a new magic packet is created. This takes the form of an Ethernet frame containing (in hexadecimal) bytes FO FO FO FO FO FO followed by sixteen repetitions of a MAC (medium access control) address of a target device. This new magic packet is able to request a target device to go into light standby mode. In the example of the building 1, this new magic packet is able to request that the set top box 11 goes into light standby mode.

In one embodiment, each message containing a request to go into light standby mode transmitted during step 31 is transmitted in broadcast mode without specifying a destination. In this way, by transmitting only one message, the electricity meter 10 can request that a plurality of devices go into light standby mode simultaneously.

In one embodiment, the method described in relation to FIG. 3 is implemented regularly by the processing module 10. For example, the method described in relation to FIG. 3 is implemented every twenty minutes.

In one embodiment, when no human presence has been detected during step 30 (for example following the implementation of step 317), the processing module 10 sends a message requesting that the set top box 11 go into deep standby mode.

FIG. 5 illustrates schematically a method for determining an operating mode of the set top box 11.

The processing module 110 of the set top box 11 is constantly listening for messages coming from the processing module 100 of the electricity meter 10, whether it be in deep standby mode, in light standby mode or in active mode.

In a step 51, the processing module 110 receives a message by means of the communication network requesting that the set top box 11 go into light standby mode, the message having been sent by the electricity meter 10 following a detection of a human presence in the building 1 by a human-presence detection procedure based on an analysis of the electrical consumption in the electrical network 12.

In a step 52, the processing module 110 causes the set top box 11 to go into light standby mode.

In one embodiment, the set top box 11 may be in a plurality of states according to at least one predetermined criterion. In a first state, known as blocked light standby state, the operating mode of the set top box 11 is forced to light standby mode. In a second state, known as blocked deep standby state, the operating mode of the set top box 11 is forced to deep standby mode. In a third state, known as intermediate state, the operating mode of the set top box 11 is not forced. The set top box 11 takes into account a message requesting that the set top box 11 go into light standby mode (or a message requesting going into deep standby mode) only when it is in the third state.

In one embodiment, a predetermined criterion is a set of time ranges comprising a time range during which the equipment is in the first state, a time range during which the equipment is in the second state and a time range during which the equipment is in the third state. For example, in a “24 hours” day, the set top box is in the first state between “5 pm” and “10 pm”, in the second state between midnight and “6 am” and between “10 pm” and midnight, and in the third state the rest of the time. It therefore suffices for the processing module 110 to know a current time in order to know in what state the set top box 11 is.

Methods for automatically determining periods during which an item of equipment must be in deep standby mode or in light standby mode are known. These methods, such as the method described in the patent FR 2984541, are based on an analysis of times of use of the equipment by one or more users. From this analysis, a processing module of the equipment determines times when a probability of use of the equipment is high and where consequently the deep standby mode must be prohibited in order to allow a quick change to active mode. The processing module of the electronic equipment also determines times when the probability of use of the equipment is low and where consequently the electronic equipment must be put on deep standby in order to save on energy. These methods therefore allow to determine time ranges in which the equipment is in the first state (i.e. blocked light standby state). Moreover, over a day of 24 hours, the periods that do not correspond to time ranges during which the equipment is in the first state are by default considered to be time ranges during which the equipment may be in the second state (i.e. blocked deep standby state). In one embodiment, the invention allows to systematically add time ranges corresponding to the intermediate state (third state) at the start and/or end of each time range during which the equipment (here the set top box 11) is in the first state (blocked light standby state). For example, if over a “24 hour” day, a time range from the start time H1 to the end time H2 is determined as having to be a time range during which the set top box 11 is in a first state, then a time range corresponding to the intermediate state is fixed at between H1−30 minutes and H1 and between H2 and H2+15 minutes. Over a “24 hour” day, the periods that do not correspond to time ranges during which the set top box 11 is in the first or third state are by default considered to be time ranges during which the set top box 11 is in the second state. In some cases, a method suitable for automatically determining periods during which an item of electronic equipment must be in deep standby mode or in light standby mode does not make it possible to determine with sufficient reliability whether a time range must correspond to the first state or to the second state. In this case, these time ranges are automatically defined as time ranges during which the set top box 11 must be in the third state (i.e. intermediate state).

In one embodiment, the set top box 11 comprises an ambient light sensor. In this embodiment, the predetermined criterion depends on ambient brightness measured by the ambient light sensor. In this embodiment, the set top box 11 is in the first state (blocked light standby state) when the ambient light sensor measures high brightness above a predetermined brightness threshold and in the third state when the ambient light sensor measures low brightness below a predetermined brightness threshold. This is because, when the natural brightness is high, there is little chance that the user will switch on the light. In the case of a procedure for the detection of human presence based on an observation of the switching on of a lighting system (such as the method described in relation to FIG. 4), the user would not then be detected. To overcome this, the light standby mode is forced when the ambient brightness is high. When the ambient brightness is low, a user should switch on the light on entering the building 1. In this case, the processing module can take into account the messages requesting that the set top box 11 go into light standby mode coming from the electricity meter 10.

In one embodiment, a plurality of predetermined criteria are used to define the state of the set top box 11 comprising for example a set of time ranges and information obtained from a brightness sensor. One of the criteria may take precedence over the other. For example, the criterion based on the brightness information may take precedence over time ranges. Thus if, in a time range corresponding to the third state (i.e. intermediate state), the brightness sensor indicates that the ambient brightness is high, the processing module 110 may cause the set top box 11 to go into the first state (i.e. blocked light standby mode).

FIG. 6 illustrates schematically a detail of the method for determining an operating mode of the set top box 10.

In one embodiment, the method described in relation to FIG. 6 is implemented during step 52.

In a step 521, the processing module 110 receives a message requesting that the set top box 11 go into light standby mode.

In a step 522, the processing module 110 checks whether the set top box 11 is in the blocked light standby mode. If such is the case, in a step 524 the processing module 110 performs no action since it is already in the light standby mode.

Otherwise the processing module 110 passes to a step 523. During step 523, the processing module 110 checks whether the set top box 11 is in the blocked deep standby state. If such is the case, in step 524 the processing module 110 does not take into account the message requesting change to light standby mode and the set top box 11 remains in deep standby mode.

When the set top box 11 is in neither the blocked light standby state nor the blocked deep standby state, the processing module 110 implements step 525. During step 525, the processing module 110 takes into account the message requesting that the set top box 11 go into light standby mode and actually causes the set top box 11 to go into light standby mode.

In a variant of the method described in relation to FIG. 6 suited to the case where the processing module 100 of the electricity meter 10 can send messages requesting that the set top box 11 go into light standby mode and messages requesting that the set top box go into deep standby mode, during step 521 the processing module 110 checks the content of the message received. If the message received contains a request to go into light standby mode, step 521 is followed by the steps 522 to 525 already explained. Otherwise the processing module 110 deduces that the message contains a request to go into deep standby mode and step 521 is followed by a step 527. During step 527 the processing module 110 checks whether the set top box 11 is in the blocked light standby state. If such is the case, in a step 529 the processing module 110 does not take the message into account and the set top box 11 remains in light standby mode.

Otherwise the processing module 110 passes to a step 528 during which the processing module 110 checks whether the set top box 11 is in the blocked deep standby state. If such is the case, in step 529 the processing module 110 does not take any action since the set top box 11 is already in deep standby mode.

When the set top box 11 is in neither the blocked light standby state nor in the blocked deep standby state the processing module 110 implements step 530. During step 530, the processing module 110 takes into account the message requesting that the set top box 11 go into deep standby mode and actually causes the set top box 11 to go into deep standby mode.

In one embodiment, when the set top box 11 is in active mode, the processing module 110 does not take into account the message requesting a change to light standby mode (or respectively a change to deep standby mode). It is considered in fact that the set top box 11 can be in active mode only following an intentional action by the user.

In one embodiment, the set top box 11 goes into deep standby mode when it is in light standby mode and does not receive any message requesting change to light standby mode for a predetermined period equal for example to 40 minutes.

1. A system comprising an item of equipment and an electricity meter, the equipment being able to function in a plurality of operating modes comprising a deep standby mode in which power consumption of said equipment is minimum, an active mode in which the power consumption of the equipment is maximum and a light standby mode in which the power consumption of the equipment is intermediate between the deep standby mode and the active mode, some of the internal devices of the equipment being deactivated and/or the power supply to these internal devices being cut off when the equipment goes into light standby mode, a change from deep standby mode to active mode being slower than a change from light standby mode to active mode, the equipment being supplied by an electrical network of a building supervised by the electricity meter, the equipment and the electricity meter being able to communicate by means of a communication network, wherein the electricity meter comprised in the system comprises electronic components configured for:
detecting a human presence in the building by analysing the electrical consumption in the electrical network;
sending a message to the equipment by means of the communication network requesting a change of the equipment to light standby mode when a human presence is detected;
receiving said message by means of the communication network, and
making the equipment go into light standby mode.

2. A method for managing an operating mode of an item of equipment that can function in a plurality of operating modes comprising a deep standby mode in which power consumption of said equipment is minimum, an active mode in which the power consumption of the equipment is maximum and a light standby mode in which the power consumption of the equipment is intermediate between the deep standby mode and the active mode, some of the internal devices of the equipment being deactivated and/or the power supply to these internal devices being cut off when the equipment goes into light standby mode, a change from the deep standby mode to the active mode being slower than a change from said light standby mode to the active mode, the equipment being supplied by an electrical network of a building supervised by an electricity meter able to communicate with the equipment by means of a communication network, the method implemented by the electricity meter comprising:
using a procedure for detecting a human presence in the building based on an analysis of the electrical consumption in the electrical network; and,
when a human presence is detected, sending a message to the equipment, by means of the communication network, requesting that the equipment go into light standby mode.

3. The method according to claim 2, wherein the building comprises a plurality of zones and the electricity meter is able to measure electrical consumption in each of the zones independently, said message being sent when a human presence is detected in at least one of the zones.

4. The method according to claim 2, wherein the procedure for detecting a human presence based on an analysis of the electrical consumption comprises detecting at least a variation in an electrical power consumed in said electrical network.

5. The method according to claim 2, wherein the building comprises a plurality of devices, each device being associated with a type of electrical consumption, and in that the electricity meter is capable of measuring a current consumption by type of electrical consumption, said message being sent when a consumed electrical power higher than a predefined threshold is detected for at least one type of electrical consumption.

6. The method according to claim 2, wherein the consumed electrical power is that of at least one lighting device supplied by the electrical network.

7. The method according to claim 2, wherein the procedure for detecting a human presence based on an analysis of the electrical consumption comprises seeking at least one electrical consumption profile characteristic of a human presence in the building.

8. A method for managing an operating mode of an item of equipment that can function in a plurality of operating modes comprising a deep standby mode in which power consumption of said equipment is minimum, an active mode in which the power consumption of the equipment is maximum and a light standby mode in which the power consumption of the equipment is intermediate between the deep standby mode and the active mode, some of the internal devices of the equipment being deactivated and/or the electrical supply to these internal devices being cut off when the equipment goes into light standby mode, a change from deep standby mode to active mode being slower than a change from light standby mode to active mode, the equipment being supplied by an electrical network of a building supervised by an electricity meter able to communicate with the equipment by means of a communication network, the method used by the equipment comprising:
receiving a message by means of the communication network requesting change of the equipment to light standby mode, the message having been sent by the electricity meter following detection of a human presence in the building by a procedure for detecting a human presence based on an analysis of the electrical consumption in the electrical network, and
causing the equipment to go into light standby mode.

9. The method according to claim 8, wherein, the equipment may be in a plurality of states according to at least one predetermined criterion, the plurality of states comprising a first state in which the operating mode is forced to light standby mode and/or a second state in which the operating mode is forced to deep standby mode and a third state in which the operating mode is not forced, the equipment taking into account a message requesting a change of the equipment to light standby mode only when it is in the third state.

10. The method according to claim 9, wherein a predetermined criterion is a set of time ranges comprising a time range during which the equipment is in the first state, a time range during which the equipment is in the second state and a time range during which the equipment is in the third state.

11. The method according to claim 10, wherein each time range corresponding to the first and second states is determined by a procedure for automatically determining periods during which the equipment must be in deep standby mode or in light standby mode, said procedure being based on an analysis of moments of use of the equipment by at least one user, a time range of a predetermined duration and corresponding to the third state being added before and/or after each time range corresponding to the first state determined by said procedure.

12. The method according to claim 9, wherein a predetermined criterion is a level of brightness in at least one zone of the building, the equipment being in the first state when the level of brightness is above a predefined threshold and in the third state when the level of brightness is below said predefined threshold.

13. An electricity meter comprising means for implementing the method according to claim 2.

14. An electricity comprising means for implementing the method according to claim 8.

15. (canceled)

16. A non transitory storage medium, storing a computer program comprising program code instructions which can be loaded in a programmable device to cause said programmable device to implement the method according claim 2, when said program is executed by a processor of said device.

17. A non transitory storage medium, storing a computer program comprising program code instructions which can be loaded in a programmable device to cause said programmable device to implement the method according to claim 8, when said program is executed by a processor of said device.
